(19) United States
(12) Patent Application Publication
(10) Pub. No.: US 2011/0146082 A1
(43) Pub. Date: Jun. 23, 2011

(54) UTENSIL WITH DETACHABLE DENTAL HYGIENE MECHANISM

(76) Inventors: Kamran Hassanpour, Glendale, CA (US); Shahnoosh Shawn Tinoosh, Tustin, CA (US)

(21) Appl. No.: 12/338,713

(22) Filed: Dec. 18, 2008

(51) Int. Cl. A47J 43/28; A61C 15/02

(52) U.S. Cl. 30/147; 132/328

(57) ABSTRACT

In accordance with one embodiment, a utensil with detachable toothpick and floss is provided. The utensil comprises a handle portion; an implement portion connected to one end of the handle portion; and a separable portion connected to another end of the handle portion, wherein the separable portion comprises a toothpick and floss. In accordance with another embodiment, a utensil with a detachable dental hygiene component is provided. The utensil comprises a handle portion; an implement portion connected to one end of the handle portion; and a separable portion connected to another end of the handle portion, wherein the separable portion comprises a dental hygiene component.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### TECHNICAL FIELD

The present invention relates generally to utensils and, more particularly, to utensils with detachable components that can be utilized to enhance dental hygiene.

### BACKGROUND

Generally, utensils comprise an implement portion and a handle portion. The implement portion is the portion that comes into contact with food, while the handle portion is the portion that is grasped by a user.

Though utensils are primarily used for eating, utensils may also include a component to serve a secondary function. Utensils have been designed that have a toothpick or even a dispenser to dispense food-related items such as condiments. See, for example, U.S. Patent Publication No. 2008/0072432 filed on Jun. 29, 2007.

Unfortunately, such utensils incorporate the component into the handle portion, making the handle portion bulky or otherwise uncomfortable for a user to grasp. Further, such utensils fail to serve more than one secondary function.

Improved utensils are needed that can overcome the above-mentioned shortcomings.

### SUMMARY

For purposes of summarizing, certain aspects, advantages, and novel features have been described herein. It is to be understood that not all such advantages may be achieved in accordance with any one particular embodiment. Thus, the claimed subject matter may be embodied or carried out in a manner that achieves or optimizes one advantage or group of advantages without achieving all advantages as may be taught or suggested herein.

In accordance with one embodiment, a utensil with detachable toothpick and floss is provided. The utensil comprises a handle portion; an implement portion connected to one end of the handle portion; and a separable portion connected to another end of the handle portion, wherein the separable portion comprises a toothpick and floss.

In accordance with another embodiment, a utensil with a detachable dental hygiene component is provided. The utensil comprises a handle portion; an implement portion connected to one end of the handle portion; and a separable portion connected to another end of the handle portion, wherein the separable portion comprises a dental hygiene component.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 provides front and side views of a utensil with toothpick and floss separable from the center of an end of the handle portion, in accordance with one embodiment.

FIG. 2 provides front and side views of a utensil with toothpick and floss separable from one side of an end of the handle portion, in accordance with one embodiment.

FIG. 3 provides front and side views of a utensil with toothpick and floss separable from a hollow cavity on an end of the handle portion, in accordance with one embodiment.

FIGS. 4A through 4C provide front views of a utensil with toothpick, floss, and a cover portion, in accordance with one or more embodiments.

FIGS. 5A and 5B provide front views of a spoon and knife with toothpick, floss, and a cover portion, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF EXEMPLARY EMBODIMENTS

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

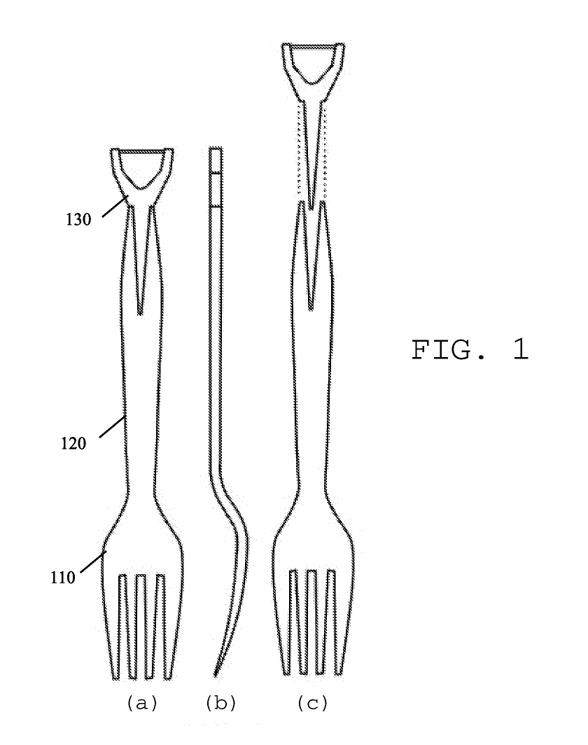

Referring to FIG. 1, in accordance with one embodiment, a utensil comprises an implement portion 110, a handle portion 120, and a detachable or separable portion 130. The implement portion 110 is connected to one end of the handle portion 120, and the separable portion 130 is connected to the other end of the handle portion 120, as shown in FIG. 1(a).

As provided earlier, the implement portion 110 is the portion that comes into contact with food, while the handle portion 120 is the portion that is grasped by a user. The separable portion 130 in one implementation may comprise a dental hygiene component, such as a toothpick component, a floss component, or a combination of several components such that each component is separable from the handle portion 120, as shown in FIG. 1(c). The utensil may be made of a material (e.g., plastic) such that a user may easily break or snap off the separable portion 130 from the handle portion 120 to detach the dental hygiene components from the handle portion 120 for further use.

In one embodiment, the separable portion 130 has a snap-fit construction, for example, to provide an operational relationship between the detachable hygiene component and an end of the handle portion 120. Accordingly, extending or interleaving the hygiene component with the end the handle portion 120 does not result in the handle portion 120 being bulky, as shown in the FIG. 1(b). Also, as a result of the above implementation, the surface of the utensil may have a smooth construction so that the toothpick when connected to the handle portion 120 is unlikely to prick or injure a user's hands or fingers.

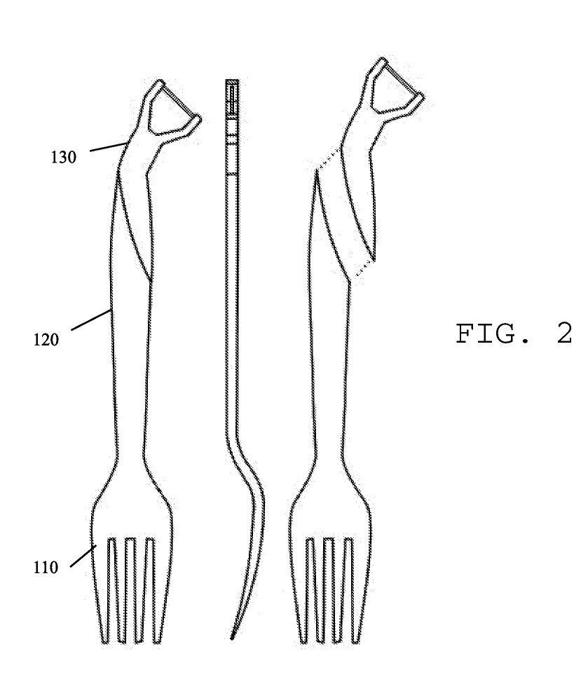

Alternatively, in accordance with another embodiment, the separable portion 130 is connected at an angle, or to one side, of the handle portion 120, as shown in FIG. 2, instead of being an extension of or interleaved with the end of the handle portion 120.

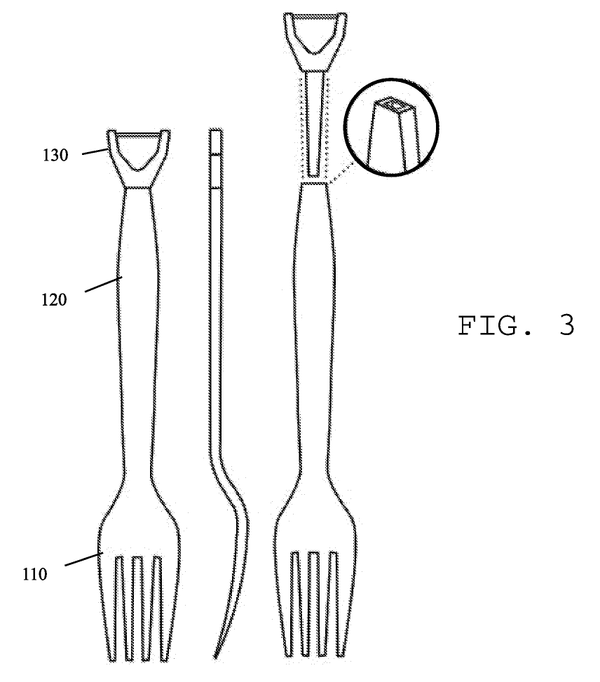

In yet another embodiment, the separable portion 130 may be connected to the handle portion 120 by way of a hollow cavity in the handle portion 120, as shown in FIG. 3. The separable portion 130 is removably insertable into the hollow cavity such that the separable portion 130 may be re-inserted into the hollow cavity to connect the separable portion 130 to the handle portion 120 again after being separated.

It is noteworthy that the utensil may be made from a variety of different materials such as plastic, wood, stainless steel, etc. By way of example, one or more embodiments as disclosed herein are suggested to be made of material such as plastic that can be easily broken or snapped off by a user. The exemplary utensils disclosed here are also designed to be disposable. It is noteworthy, however, that in other implementations the eating utensils may also reusable if made of material that are durable and suitable for washing and long-term use.

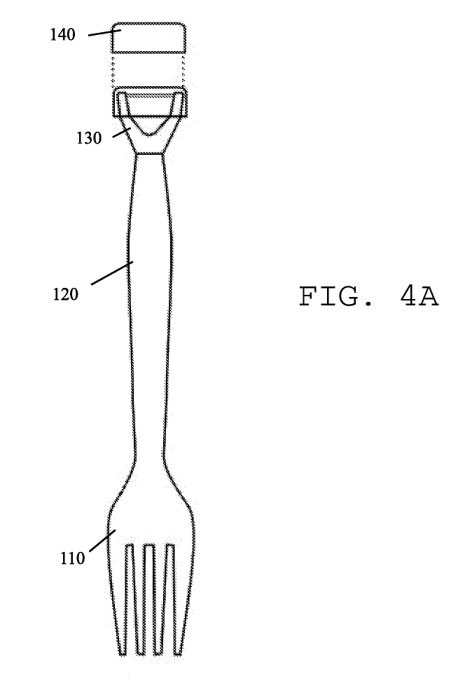

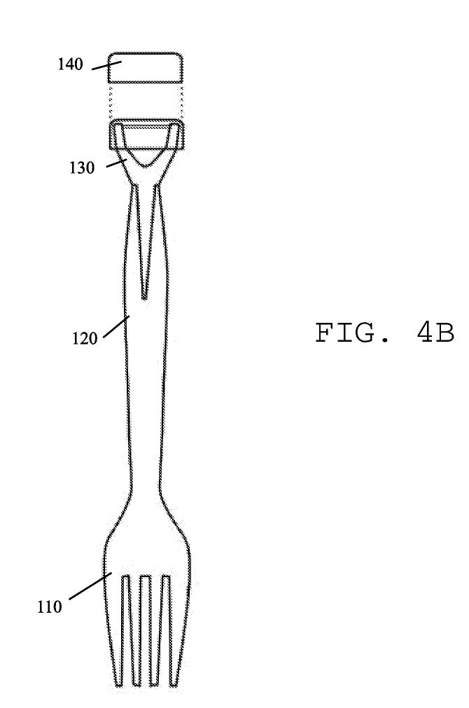

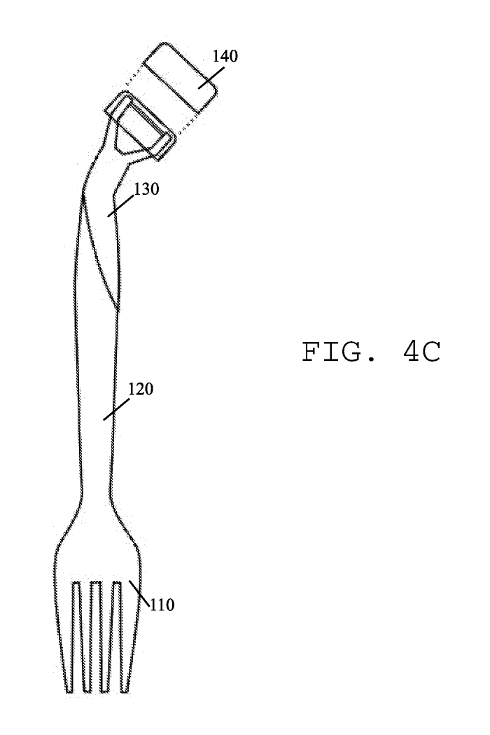

Referring to FIGS. 4A through 4C, in accordance with one or more embodiments, a utensil may comprise a cover portion 140, in addition to the implement portion 110, the handle portion 120, and the separable portion 130. The cover portion 140 may be used to cover the hygiene component (e.g., a floss) implemented on the separable portion 130.

In FIG. 4A, in accordance with one embodiment, a cover portion 140 covers the floss on a separable portion 130 that is an extension of or is interleaved with a handle portion 120. In FIG. 4B, in accordance with one embodiment, a cover portion 140 covers the floss on a separable portion 130 that is connected at an angle to handle portion 120. In FIG. 4C, in accordance with one embodiment, a cover portion 140 covers the floss on a separable portion 130 that is removably inserted into a hollow cavity in one end of the handle portion 120.

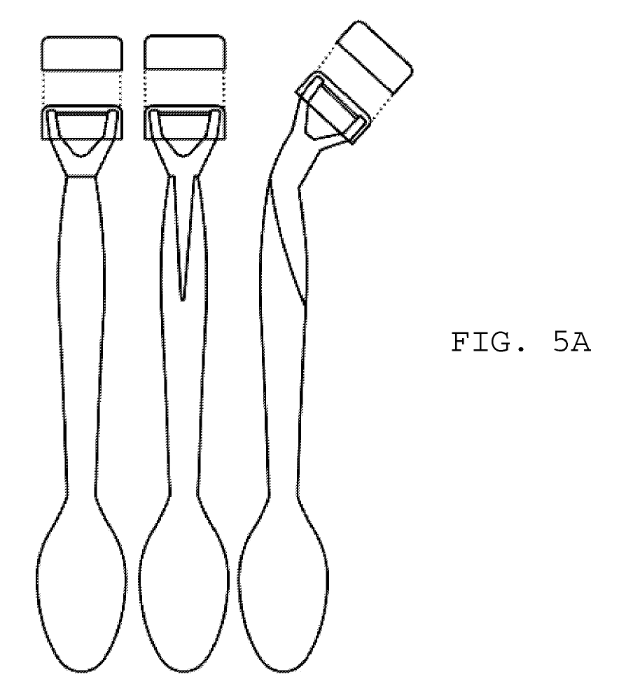

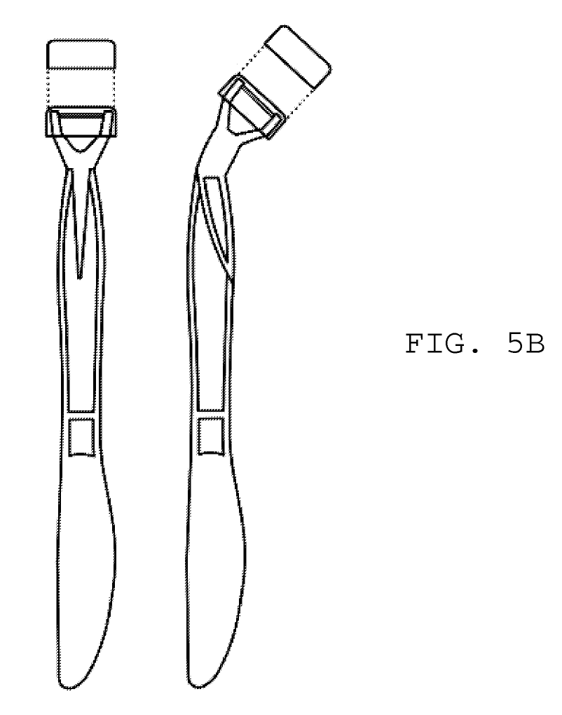

The present invention has been described above with reference to one or more features or embodiments. Those skilled in the art will recognize, however, that changes and modifications may be made to these embodiments without departing from the scope of the claimed subject matter. For example, the above features or embodiments may be applicable to a spoon, as shown in FIG. 5A, a knife, as shown in FIG. 5B, or other utensils, in addition to a fork. These and various other adaptations and combinations of the embodiments disclosed are within the scope of the claimed subject matter and are further defined by the claims and their full scope of equivalents.

1. A monolithic utensil floss combination comprising:
a handle portion;
an implement portion connected to one end of the handle portion, wherein the implement portion comprises one of a fork, a spoon or a knife; and
a separable portion connected to another end of the handle portion, wherein the separable portion, when detached from the handle portion comprises one end that is formed in shape of a toothpick and another end that is formed as a U-shaped floss assembly having a dental floss thread extending from a first end of the U-shaped floss assembly to a second end of the U-shaped floss assembly, wherein ends of the dental floss thread are securely held in the first end and the second end of the U-shaped floss assembly;
wherein the handle portion, at the end that is connected to the separable portion, is configured such that the separable portion is frangibly separable from the handle portion as the result of application of pressure,
wherein after the end of the handle portion is separated from the separable portion, a V-shaped groove is formed in said end of the handle portion such that the V-shaped groove is approximately central to width of the end of the handle portion and results in said end of the handle portion to include two separate projections,
wherein a first one of said projections is tapered toward the separated end of the handle to a first point, and a second one of said projections is tapered toward the separated end of the handle to a second point, wherein either of the first projection or the second projection is usable as a toothpick,
wherein after the separable portion is separated from the from the handle portion, the separable portion comprises a third projection extending in an opposite direction from the U-shaped floss assembly such that the third projection is tapered toward the separated end of the separable portion to a third point such that the third projection is usable as a toothpick.

2. The utensil of claim 1, further comprising a cover for the floss.

3. The utensil of claim 1, wherein the separable portion has a snap-fit construction to allow for a detachable operational relationship between the handle portion and the separable portion.

4. The utensil of claim 3, wherein the separable portion is an extension of the handle portion.

5. The utensil of claim 3, wherein the separable portion is connected at an angle to the handle portion.

6. The utensil of claim 3, wherein the separable portion is detached from the handle portion in response to a user exerting a certain amount of pressure to the separable portion.

7. The utensil of claim 3, wherein the utensil is made of plastic material.

8. The utensil of claim 1, wherein the separable portion is removably inserted into a hollow cavity in the handle portion.

9. The utensil of claim 1, wherein the utensil is made of reusable material.

10. The utensil of claim 1, wherein the utensil is one of a fork, spoon, or knife.

11. A utensil comprising:
a handle portion;
an implement portion connected to one end of the handle portion; and
a separable portion connected to another end of the handle portion, wherein the separable portion comprises a dental hygiene component including a U-shaped flosser,
wherein the separable portion is connected to the other end of the handle portion by way of a frangible grooved area formed diagonally along the handle portion such that a first end of the groove starts from a first edge of the handle portion and ends on a second edge of the handle portion, wherein the first edge is on the opposite end from the second edge, wherein when pressure is applied by a user of the utensil to the separable portion, the separable portion is snapped off from the handle portion along the grooved area in the diagonal direction, such that after the separable portion is snapped off, an end of the separable portion that was connected to the handle portion is tapered to a first point, and an end of the handle portion that was connected to the separable portion is tapered to a second point, wherein the first point and the second point are usable as tooth pick,
wherein the handle portion, the implement portion and the separable portion are monolithically formed.

12. The utensil of claim 11, further comprising a cover for the dental hygiene component.

13. The utensil of claim 11, wherein the separable portion has a snap-fit construction to allow for a detachable operational relationship between the handle portion and the separable portion.

14. The utensil of claim 13, wherein the separable portion is an extension of the handle portion.

15. The utensil of claim 13, wherein the separable portion is connected at an angle to the handle portion.

16. The utensil of claim 13, wherein the separable portion is detached from the handle portion in response to a user exerting a certain amount of pressure to the separable portion.

17. The utensil of claim 13, wherein the utensil is made of plastic material.

18. The utensil of claim 11, wherein the separable portion is removably inserted into a hollow cavity in the handle portion.

19. The utensil of claim 11, wherein the utensil is made of reusable material.

20. The utensil of claim 11, wherein the utensil is one of a fork, spoon, or knife.
